(19) United States
(12) Patent Application Publication
(10) Pub. No.: US 2004/0244545 A1
(43) Pub. Date: Dec. 9, 2004

(54) Tool handle with crawling traction fist support and hands free function

(76) Inventors: Marcel Stinnissen, Redondo Beach, CA (US); Bradford Tyler Sorensen, Manhattan Beach, CA (US)

Correspondence Address: BRAD FORD SORENSEN, 515 13TH STREET, MANHATTAN BEACH, CA, 90266, US

(21) Appl. No.: 10/860,974

(22) Filed: Jun. 3, 2004

Related U.S. Application Data
(60) Provisional application No. 60/475,641, filed on Jun. 4, 2003.

(51) Int. Cl. B25G 1/01

(52) U.S. Cl. 81/489; 7/145; 254/19

(57) ABSTRACT

A tool handle with crawling traction for the human fist and support for the human body in a hands and knees crawling position and use of the fingers and thumb while holding the tool in a active position, ready for use. The tool handle also provides support and traction for the human body in horizontal, diagonal and vertical tool positions. The tool handle also provides multiple hand positions within a handle channel for instant hand repositioning without risk of losing control of the tool.

### FIELD OF THE INVENTION

The current invention relates to the field of tool handles with ergonomic, useful, convenient functions. In particular to tool handles that provide the secondary function of supporting the human body in a hands and knees, crawling position as well as providing a hands free use of the fingers and thumb while the tool is connected to the human hand.

### BACKGROUND

Traditionally, tool handles have been variations on solid, stiff, cylindrical, shafts with hand engaging grips allowing a comfortable combination between the tool and the human body at the point of contact in with the human hand.

Traditional tool handles used in applications such as crawling on a roof while nailing shingles or crawling in a crawl space under a house while using a pry, hammer or a wrench fail to provide knuckle protection and fist supporting traction under the hand while crawling with the tool in hand. An important problem with previous art tool handles and grips is that they do not take into account the fact that the tool handle does not have a means for human body support and does not provide protection and traction in a hands and knees, crawling position with the tool in an active position in the hand.

Another problem with previous art tool handles is that when the tool handle is gripped in a loose manner, the tool can slip out of the hand causing a dangerous projectile or falling hazard in a roofing hammer application for example.

Traditional tool handles provide little or no protection for the knuckles and other exposed areas of the hand during use such as hammering in tight spaces, prying broken glass and moving wrenches in tight automobile engine compartments.

Previous art tool handles require the firm wrapping of the human fingers and thumb around the tool handle to be operated under forces and loads related to doing work. Traditionally, when the fingers and thumb of the human hand are spread open, the handle falls out of the hand and out of the control of the human.

Previous art tool handles fail to provide hands free use of the fingers and thumb while maintaining control of the tool in an active position, ready for instant use.

Generally, traditional tool handles are made of solid material in order to be strong while being light weight. Previous art tool handles with solid handles fail to take advantage of several functions and improvements available through the use of hollow tool handles.

Traditional tool handles generally do not have a large connector loop for instant connection to a hook on a tool belt.

Generally, previous art tool handles do not employ heavy liquid moving inside hollow internal chambers providing high inertial weight leverage advantage on the power stroke and low energy use on the tool backstroke.

Traditional tool handles do not use liquids or gels moving in hollow chambers to dampen vibration.

Traditional tool handles do not use liquids or gels moving in hollow chambers to isolate impact forces to the tool head instead of the human hand.

### SUMMARY OF THE INVENTION

The present invention provides solutions to the problems found in previous art tool handles.

The current invention has been described and illustrated as tool handle with a support for the hand of the human body in a hands and knees, crawling position. The present invention tool handle employs a human body weight supporting traction bar that protects the knuckles of the hand while in a hands and knees, crawling position.

The current invention has been described and illustrated as tool handle with a human hand engaging means for providing a hands free opportunity to use the fingers and thumb of the human hand to do other tasks while retaining the tool in an active, useful position, ready for instant utilization.

The current invention has been described and illustrated as tool handle with a human hand engaging means for providing a secure connection with the human hand providing less chance of accidental dropping of the tool even with a loose grip.

The current invention has been described and illustrated as tool handle with a human hand engaging means for providing a multiple leverage hand positions in relationship to tool head location. This provides for an accurate, low leverage, high accuracy, and low impact speed first hand position transitioning to a less accurate, high leverage, lower accuracy, and high impact speed second hand position.

The current invention has been described and illustrated as a tool handle with a human hand engaging means for providing a hollow handle containing a heavy liquid which provides an extra leverage weight force during application of the tool and less leverage weight upon tool backstroke.

The current invention has been described and illustrated as a tool handle with a hollow handle containing a heavy liquid which provides an extra leverage weight force energy during application of the tool and less leverage weight upon tool backstroke to save energy.

The current invention has been described and illustrated as a tool handle with a hollow handle using liquids or gels moving in hollow chambers to isolate impact forces to the tool head instead of the human hand.

The current invention has been described and illustrated as a tool handle with a hollow handle using liquids or gels moving in hollow chambers to act as a counter force to the main forces of impact in order to reduce vibration to the human hand.

The present invention is primarily directed to the tool handle application; however, multiple other uses of the current invention are also unique, efficient and desirable. The use of this handle in a hands and knees, crawling position could be very useful in the firearms handle applications, in the sporting goods applications, in the mountain climbing applications, in the mining applications, in the cleaning applications and other applications where the human body engages implements while in a hands and knees, crawling position.

### OBJECTS OF THE INVENTION

A first object of the present invention is to provide a tool handle with means of supporting the human body in a hands and knees, crawling position.

A second object of the present invention is to provide a tool handle with means of providing traction while supporting the human body in a hands and knees, crawling position.

A third object of the present invention is to provide a tool handle with means of providing protection for the knuckles while supporting the human body in a hands and knees, crawling position.

A fourth object of the present invention is to provide a tool handle with means of providing protection for the knuckles of the human hand while hammering nails.

A fifth object of the present invention is to provide a tool handle with means of providing multiple positions of hand locations in relationship to tool head location.

A sixth object of the present invention is to provide a tool handle with means of providing a secure connection with the tool without a tight grip.

A seventh object of the present invention is to provide a tool handle with means of providing a hands free use of the fingers and thumb while maintaining the tool in an active position, ready for instant use.

An eighth object of the present invention is to provide a tool handle with a large loop for instant connection to a hook on a tool belt.

A ninth object of the present invention is to provide a tool handle with a multiple center of gravity balance point adjustment facility for adjusting the weight distribution of different tools for a variety of tool functions.

A tenth object of the present invention is to provide a tool handle with an enclosed multiple grip channel allowing the instant repositioning of hand grip locations without risk of losing control of the tool as a whole.

An eleventh object of the present invention is to provide a tool handle with a hollow handle containing a liquid which provides an impact absorbing function.

A twelfth object of the present invention is to provide a tool handle with a hollow handle containing a liquid which provides an anti-vibration function.

A thirteenth object of the present invention is to provide a tool handle with a hollow handle containing a stiff shaft which provides strength, bounce and stiffness to the handle.

A fourteenth object of the present invention is to provide a tool handle with a hollow handle containing a heavy liquid which provides an extra leverage weight force energy during application of the tool and less leverage weight upon tool backstroke to save energy.

A fifteenth object of the present invention is to provide a tool handle with a hollow handle using liquids or gels moving in hollow chambers to isolate impact forces to the tool head instead of the human hand.

A sixteenth object of the present invention is to provide a tool handle with a hollow handle using liquids or gels moving in hollow chambers to act as a counter force to the main forces of impact in order to reduce vibration to the human hand.

A seventeenth object of the present invention is to provide a tool handle with multiple hand position grips which individually enclose a hand in each location allowing the hands-free, finger and thumb freedom to hold and manipulate other materials while keeping the tool handle in an active, ready position for instant use.

### BRIEF DESCRIPTION OF THE DRAWINGS

The invention, together with the further objects and advantages thereof, may be best understood by reference to the following descriptions taken in conjunction with the accompanying drawings, wherein the reference numerals identify like elements, and wherein:

FIG. 1 is a perspective view of the tool handle, in three applications, in accordance with the present invention, illustrating use of the multiple human body support angles, in a hands and knees, crawling position;

FIG. 2 is a perspective view of the tool handle, in accordance with the present invention, illustrating the use of the front nail pull claw function in a hands and knees crawling position;

FIG. 3 is a perspective view of the tool handle, in accordance with the present invention, illustrating the hands free, finger and thumb availability while maintaining the tool in an active position for immediate use;

FIG. 4 is a perspective view of the tool handle, in accordance with the present invention, illustrating the vibration absorbing rubberized grip with elastomeric finger bridges over gaps to isolate impact forces;

FIG. 5 is a front view of the tool handle, in accordance with the present invention, illustrating the horizontal human body supporting position;

FIG. 6 is a front view of the tool handle, in accordance with the present invention, illustrating the diagonal human body supporting position;

FIG. 7 is a front view of the tool handle, in accordance with the present invention, illustrating the vertical human body supporting position;

FIG. 8 is a front view of the tool handle, in accordance with the present invention, illustrating the multiple hand grip and front nail claw;

FIG. 9 is a centerline section view of the tool handle, in accordance with the present invention, illustrating a hollow handle and impact absorbing elastomeric finger bridges and gaps.

FIG. 10 is a centerline section view of the tool handle, in accordance with the present invention, illustrating a hollow handle containing a heavy liquid which provides an extra leverage weight force during application of the tool and less leverage weight upon tool backstroke.

FIG. 11 is a chart illustrating the movement of a heavy liquid within the hollow handle of a hammer.

Numbering of the Drawing Components

1 tool handle of preferred embodiment

2 tool head (hammer, hatchet, axe, wrench, mallet, shovel, gun, spade, fork, cutter, scraper, hook, chisel, rake, ratchet, torque wrench, jack, pump, pick, spike, lever, bar, pry . . . .)

3 tool eye

4 tool eye lock

5 upper hand position

6 upper hand guard

7 middle hand position

8 middle hand guard

9 lower hand position

10 lower hand guard

11 horizontal traction surface

12 striking tool face

13 thumb rest

14 hook loop

15 hollow handle

16 rear nail removal claw

17 front nail removal claw

18 front nail removal slot

19 handle grip cushion

20 anti-vibration thumb rest

21 anti-vibration bridge

22 anti-vibration gap

23 diagonal traction surface

24 vertical traction surface

25 movable liquid or gel

### DETAILED DESCRIPTIONS OF PREFERRED EMBODIMENTS

The drawings illustrate an improved tool handle which is a preferred embodiment of this invention.

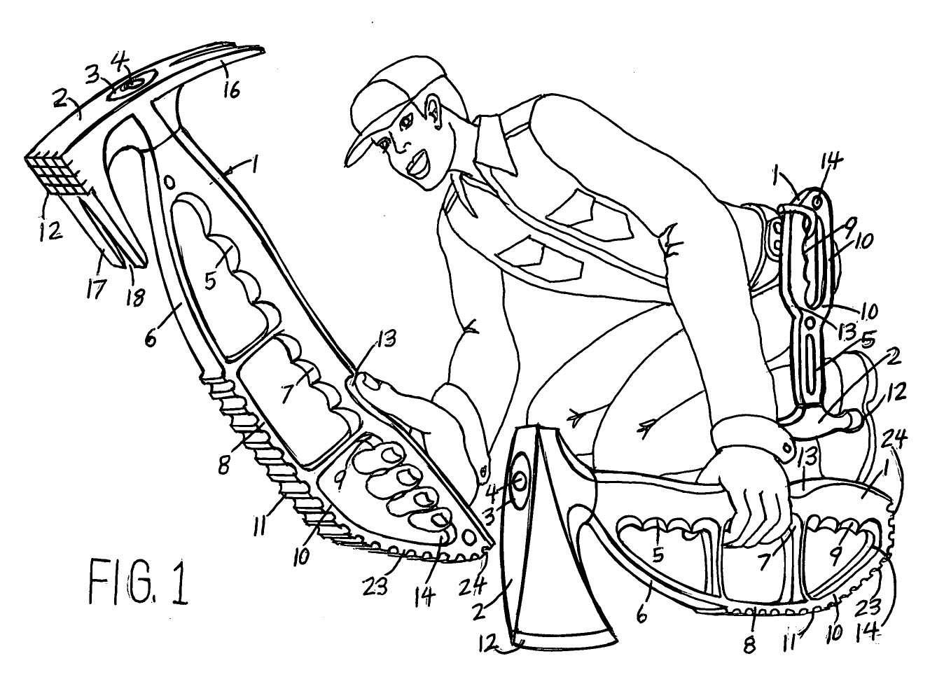

As shown in FIG. 1, illustrating the use of multiple tool handle support angles for the human body, in a hands and knees, crawling position, the 1 tool handle of preferred embodiment, in the right hand of the human user, is connected to the 2 tool head (hammer) at the 3 tool eye and permanently attached together with a 4 tool eye lock. This 2 tool head (hammer) has a 12 striking tool face located on the opposite side of the 3 tool eye from the 16 rear nail removal claw. This 2 tool head (hammer) also has a 17 front nail removal claw extending parallel to the 12 striking tool face with a 18 front nail removal slot for convenient removal of nails without turning the hammer over to use the 16 rear nail removal claw. The 1 tool handle of this preferred embodiment has a 5 upper hand position protected by a 6 upper hand guard and a 7 middle hand position protected by a 8 middle hand guard and a 9 lower hand position protected by a 10 lower hand guard. The 1 tool handle has a 13 thumb rest for added grip comfort and tool control in the 9 lower hand position. The 1 tool handle has a 14 hook loop for connection to a tool belt loop and the secondary function of securing the tool handle in the hand even when a loose grip is employed. The 1 tool handle of preferred embodiment in the right hand of the human user is shown functioning as a 23 diagonal traction surface to provide a diagonal support for the human body while in a hands and knees, crawling position with the tool in an active position for instant use. Illustrating the use of multiple tool handle support angles for the human body, in a hands and knees, crawling position, the 1 tool handle of preferred embodiment, in the left hand of the human user, is connected to the 2 tool head (hatchet) at the 3 tool eye and permanently attached together with a 4 tool eye lock. The 1 tool handle of this preferred embodiment has a 5 upper hand position protected by a 6 upper hand guard and a 7 middle hand position protected by a 8 middle hand guard and a 9 lower hand position protected by a 10 lower hand guard. The 1 tool handle has a 13 thumb rest for added grip comfort and tool control in the 9 lower hand position. The 1 tool handle has a 14 hook loop for connection to a tool belt loop and the secondary function of securing the tool handle in the hand even when a loose grip is employed. The 1 tool handle of preferred embodiment in the left hand of the human user is shown functioning as a 11 horizontal traction surface to provide a diagonal support for the human body while in a hands and knees, crawling position with the tool in an active position for instant use. Illustrating the instant utilization, tool handle, storage position, the 1 tool handle of this preferred embodiment is shown hanging from a tool hook connected by a tool belt to the human body, in a hands and knees, crawling position. The 1 tool handle of preferred embodiment is located in the instant utilization storage position, ready for immediate use, without the need to turn the hammer over like the previous art hammers of traditional design that used to be stored in a belt loop. The tool handle of this preferred embodiment has a 2 tool head (hammer) connected to the 1 tool handle. The 1 tool handle has an 5 upper hand position and has a 9 lower hand position protected by a 10 lower hand guard. The 1 tool handle has a 13 thumb rest for added grip comfort and tool control in the 9 lower hand position. The 1 tool handle has a 14 hook loop for connection to a tool belt loop and the secondary function of securing the tool handle in the hand even when a loose grip is employed.

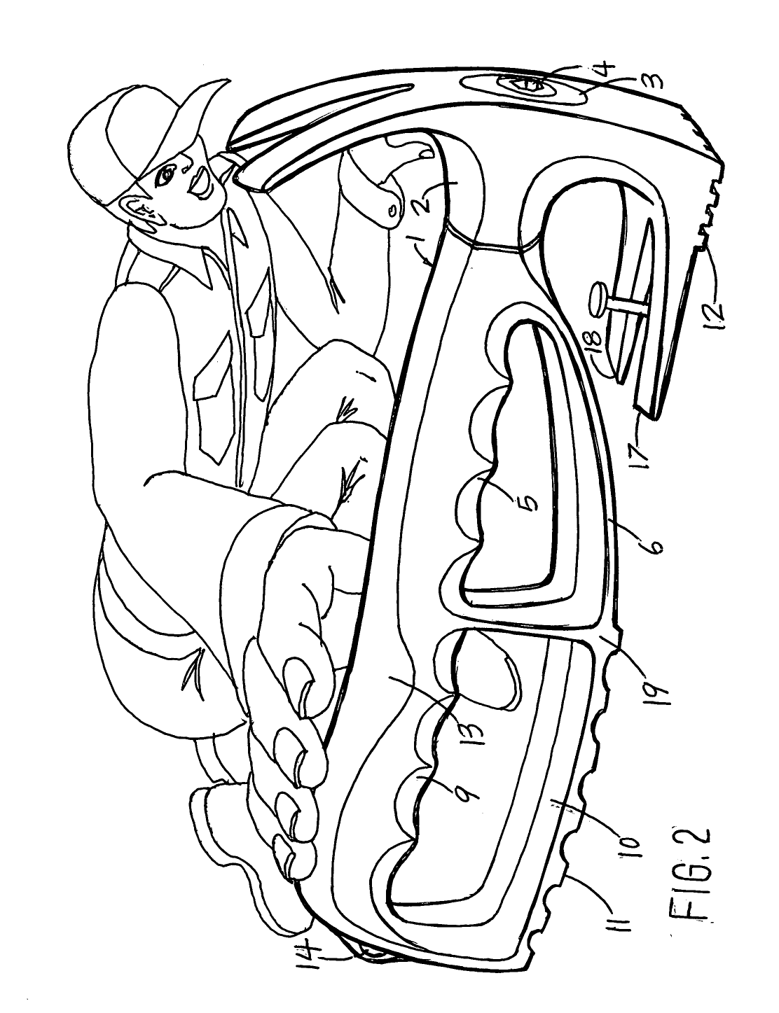

As shown in FIG. 2, illustrating the use of the front nail pull claw function in a hands and knees crawling position the 1 tool handle of preferred embodiment is attached to the 2 tool head (hammer) at the 3 tool eye and permanently attached together with a 4 tool eye lock. The 1 tool handle of this preferred embodiment has a 5 upper hand position protected by a 6 upper hand guard and a 9 lower hand position protected by a 10 lower hand guard. The hand guard has a function of providing a 11 traction surface generally in alignment with the 12 striking tool face to provide a support for the human body while in a hands and knees, crawling position with the tool in an active position for instant use. The 1 tool handle has a 13 thumb rest for added grip comfort and tool control in the 9 lower hand position. The 1 tool handle has a 14 hook loop for connection to a tool belt loop and has the secondary function of securing the tool handle in the hand even when a loose grip is employed.

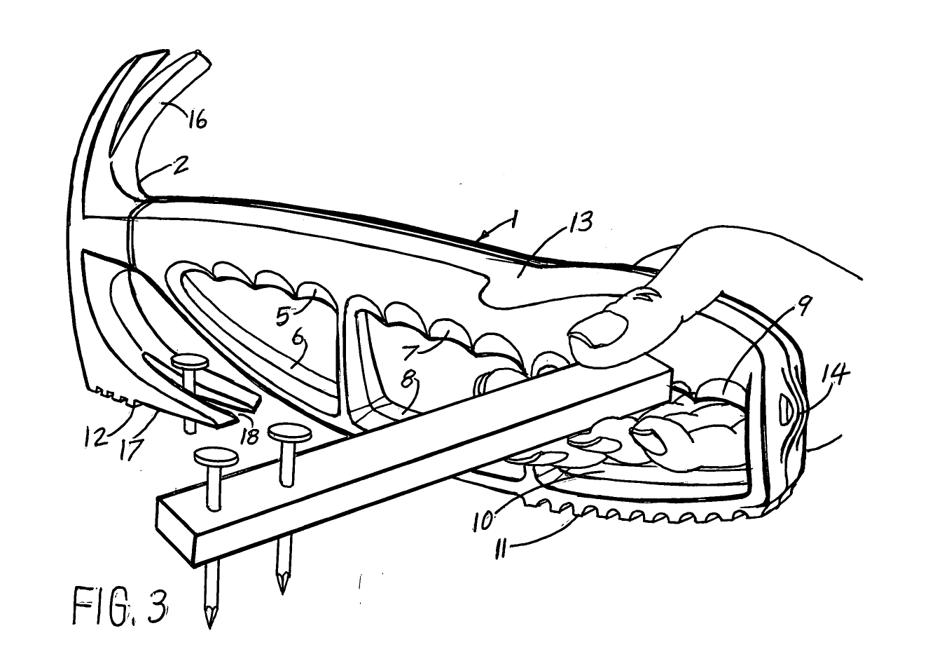

As shown in FIG. 3, illustrating the hands free, finger and thumb availability while maintaining the tool in an active position for immediate use, the 1 tool handle of preferred embodiment is connected to the 2 tool head (hammer). This 2 tool head (hammer) has a 12 striking tool face located on the opposite side of the 1 tool handle from the 16 rear nail removal claw. This 2 tool head (hammer) also has a 17 front nail removal claw extending parallel to the 12 striking tool face with a 18 front nail removal slot for convenient removal of nails without turning the hammer over to use the 16 rear nail removal claw. The 1 tool handle of this preferred embodiment has a 5 upper hand position protected by a 6 upper hand guard and a 7 middle hand position protected by a 8 middle hand guard and a 9 lower hand position protected by a 10 lower hand guard. The 1 tool handle has a 13 thumb rest for added grip comfort and tool control in the 9 lower hand position. The 1 tool handle has a 14 hook loop for connection to a tool belt loop and the secondary function of securing the tool handle in the hand even when a loose grip is employed. The 1 tool handle of preferred embodiment is shown with the fingers and thumb of the human hand free to grasp and manipulate objects while maintaining the tool in an active, ready position for instant use.

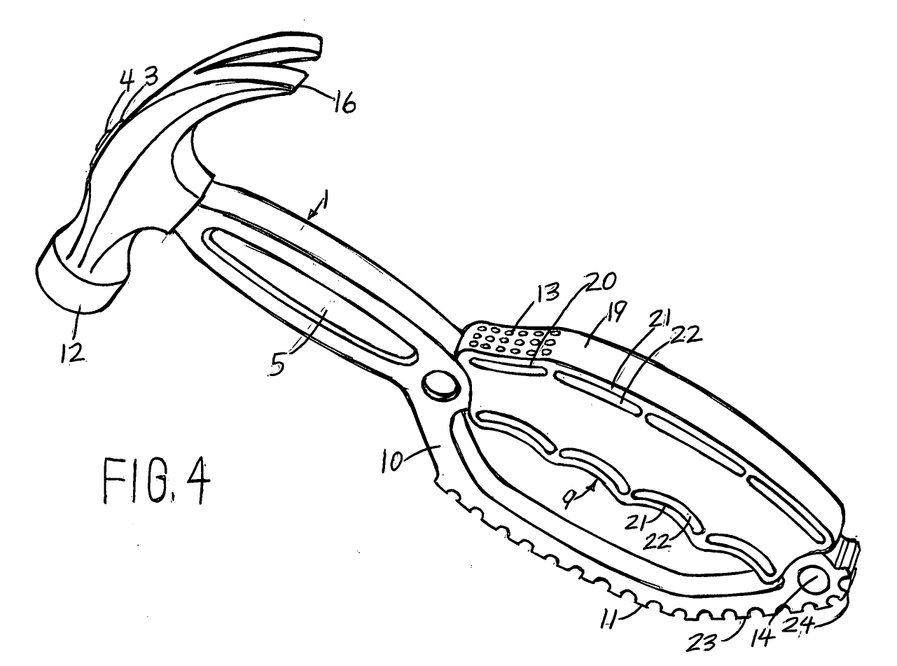

As shown in FIG. 4, illustrating the vibration absorbing rubberized grip with elastomeric 21 anti-vibration bridges over 22 anti-vibration gaps to isolate impact forces from being transferred fully to the hand of the user. the 1 tool handle of preferred embodiment is connected to the 2 tool head (hammer) at the 3 tool eye and permanently attached together with a 4 tool eye lock and a 16 rear nail removal claw. The 1 tool handle of this preferred embodiment has a 5 upper hand position and a 9 lower hand position protected by a 10 lower hand guard. The hand guard has a function of providing a 11 traction surface generally in alignment with the 12 striking tool face to provide a support for the human body while in a hands and knees, crawling position with the tool in an active, ready position for instant use. The 1 tool handle has a 19 cushioned hand grip with an 20 anti-vibration thumb rest for added grip comfort and tool control in the 9 lower hand position. The 1 tool handle has a 14 hook loop for connection to a tool belt loop and has the secondary function of securing the tool handle in the hand even when a loose grip is employed. This illustration of the 1 tool handle of preferred embodiment also shows the multiple angles of tool handle human body support including the 11 horizontal traction surface, the 23 diagonal traction surface and the 24 vertical traction surface. These traction surfaces may also be blended into a curve or radius to support an infinite number of human body support angles.

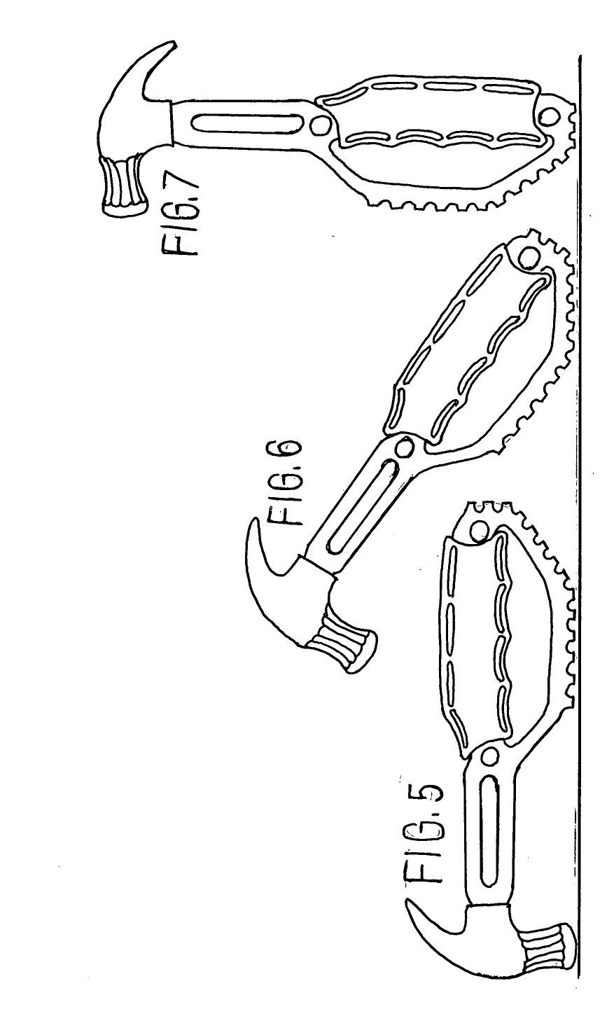

FIG. 5, illustrates the horizontal human body supporting position.

FIG. 6, illustrates the diagonal human body supporting position.

FIG. 7, illustrates the vertical human body supporting position.

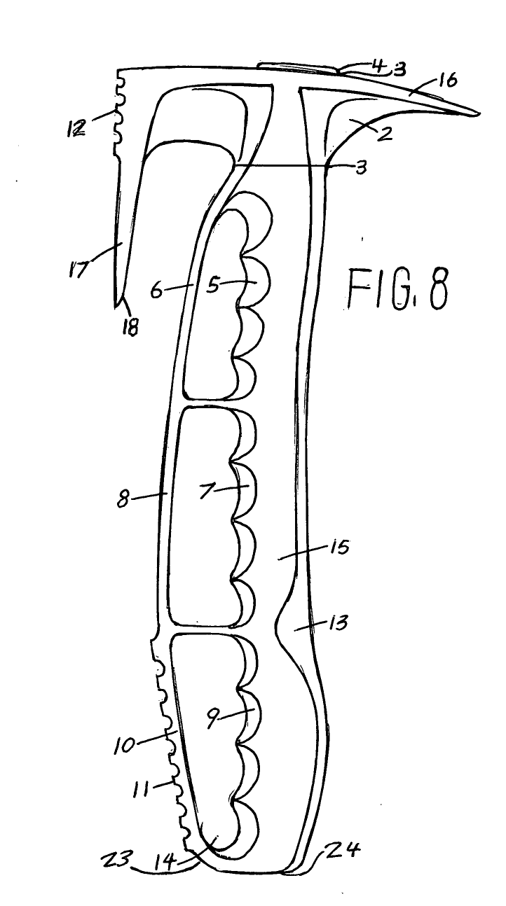

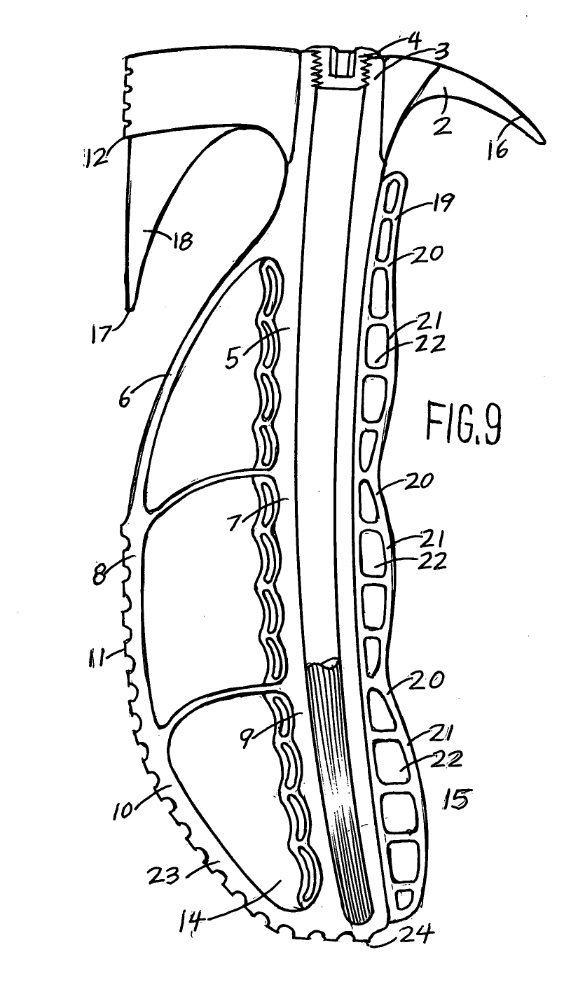

As shown in FIG. 8, illustrating the multiple hand grip and front nail claw innovations of the current invention, the 1 tool handle of preferred embodiment is attached to the 2 tool head (hammer) at the 3 tool eye and permanently attached together with a 4 tool eye lock. This 2 tool head (hammer) has a 12 striking tool face located on the opposite side of the 3 tool eye from a 16 rear nail removal claw. This 2 tool head (hammer) also has a 17 front nail removal claw extending parallel to the 12 striking tool face with a 18 front nail removal slot for convenient removal of nails without turning the hammer over to use the 16 rear nail removal claw. The 1 tool handle of this preferred embodiment has a 5 upper hand position protected by a 6 upper hand guard and a 7 middle hand position protected by a 8 middle hand guard and a 9 lower hand position protected by a 10 lower hand guard. The hand guard has a function of providing a 11 horizontal traction surface, a 23 diagonal traction surface and a 24 vertical traction surface to provide multiple angle support for the human body while in a hands and knees, crawling position with the tool in an active position for instant use. The 1 tool handle has a 13 thumb rest for added grip comfort and tool control in the 9 lower hand position. The 1 tool handle has a 14 hook loop for connection to a tool belt loop and the secondary function of securing the tool handle in the hand even when a loose grip is employed. The 1 tool handle is molded with a 15 hollow handle.

As shown in FIG. 9, illustrating a hollow handle and impact absorbing elastomeric finger bridges and gaps the 1 tool handle of preferred embodiment is attached to the 2 tool head (hammer) at the 3 tool eye and permanently attached together with a 4 tool eye lock. The 1 tool handle of this preferred embodiment has a 5 upper hand position protected by a 6 upper hand guard and a 7 middle hand position protected by a 8 middle hand guard and a 9 lower hand position protected by a 10 lower hand guard. The hand guards have a secondary function of providing a 11 traction surface generally in alignment with the 12 striking tool face to provide a support for the human body while in a hands and knees, crawling position with the tool in an active position for instant use. The 1 tool handle has a 13 thumb rest for added grip comfort and tool control in the 9 lower hand position. The 1 tool handle has a 14 hook loop for connection to a tool belt loop and the secondary function of securing the tool handle in the hand even when a loose grip is employed. The 1 tool handle is molded with a 15 hollow handle which provides many functions such as containing a liquid which provides an anti-vibration and impact absorbing function, or containing a stiff shaft which provides strength, bounce and stiffness to the handle, or containing a heavy liquid which provides an extra leverage weight force energy during application of the tool and less leverage weight upon tool backstroke to save energy, or containing liquids or gels moving in hollow chambers to isolate impact forces to the tool head instead of the human hand.

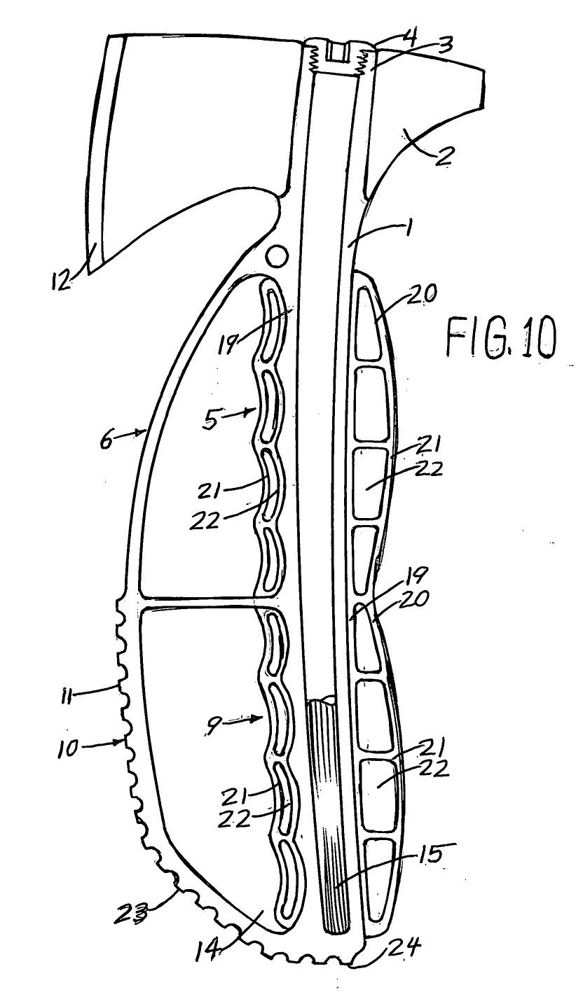

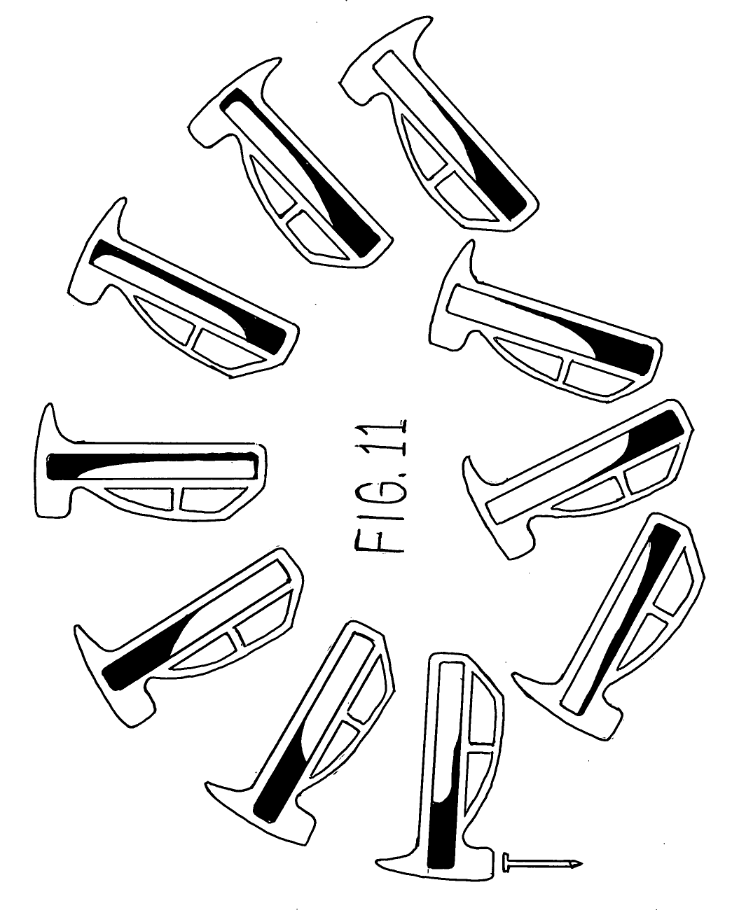

As shown in FIG. 10, illustrating the vibration absorbing rubberized grip with elastomeric 21 anti-vibration bridges over 22 anti-vibration gaps to isolate impact forces from being transferred fully to the hand of the user. the 1 tool handle of preferred embodiment is connected to the 2 tool head (axe) at the 3 tool eye and permanently attached together with a 4 tool eye lock and a 16 rear nail removal claw. The 1 tool handle of this preferred embodiment has a 5 upper hand position and a 9 lower hand position protected by a 10 lower hand guard. The hand guard has a function of providing a 11 traction surface generally in alignment with the 12 striking tool face to provide a support for the human body while in a hands and knees, crawling position with the tool in an active, ready position for instant use. The 1 tool handle has a 19 cushioned hand grip with an 20 ant-vibration thumb rest for added grip comfort and tool control in the 9 lower hand position. The 1 tool handle has a 14 hook loop for connection to a tool belt loop and has the secondary function of securing the tool handle in the hand even when a loose grip is employed. This illustration of the 1 tool handle of preferred embodiment also shows the multiple angles of tool handle human body support including the 11 horizontal traction surface, the 23 diagonal traction surface and the 24 vertical traction surface. These traction surfaces may also be blended into a curve or radius to support an infinite number of human body support angles. The 1 tool handle is molded with a 15 hollow handle which provides many functions such as containing a liquid which provides an anti-vibration and impact absorbing function, or containing a stiff shaft which provides strength, bounce and stiffness to the handle, or containing a heavy liquid which provides an extra leverage weight force energy during application of the tool and less leverage weight upon tool backstroke to save energy, or containing liquids or gels moving in hollow chambers to isolate impact forces to the tool head instead of the human hand.

FIG. 11, illustrates the movement of a heavy liquid within the hollow handle of a tool handle showing how a hollow handle containing a heavy liquid provides an extra leverage weight force during application of the tool and less leverage weight upon tool backstroke.

While the principles of this invention have been described in connection with specific embodiments, it should be understood clearly that these descriptions are made only by way of example and are not intended to limit the scope of the invention, in any manner. Other advantages and features of the invention will become apparent from the claims hereinafter, with the scope of the claims determined by the reasonable equivalents as understood by those skilled in the art.

1. A tool handle for use with a tool head such as a hammer, hatchet, axe, wrench, mallet, shovel, gun, nail gun, spade, fork, cutter, trowel, scraper, hook, chisel, rake, ratchet, torque wrench, jack, pump, pick, spike, lever, bar or pry comprising:
a handle extending from the tool head with;
an elevated bridge means, having a traction surface, for supporting and providing traction for the human body in a hands and knees, crawling position;
means of providing a hands-free, finger and thumb freedom to hold and manipulate other materials while keeping the tool handle in an active, ready position for instant use.

2. The tool handle of claim 1 including multiple hand grip locations.

3. The tool handle of claim 1 including multiple angles of surface contact including horizontal, diagonal and vertical.

4. The tool handle of claim 1 including multiple center of gravity balance point adjustment facility for adjusting the weight distribution of different tools for a variety of tool functions.

5. The tool handle of claim 1 including an enclosed multiple grip channel allowing the instant repositioning of hand grip locations without risk of losing control of the tool as a whole.

6. The tool handle of claim 1 including a hollow handle containing a substance which provides an impact absorbing function.

7. The tool handle of claim 1 including a tool handle with a hollow handle containing a substance which provides an anti-vibration function.

8. The tool handle of claim 1 including a tool handle with a hollow handle containing a stiff shaft which provides strength, bounce and stiffness to the handle.

9. The tool handle of claim 1 including a hollow handle containing a heavy liquid or other substance which provides an extra leverage weight force energy during application of the tool and less leverage weight upon tool backstroke to save energy.

10. The tool handle of claim 1 including a hollow handle using liquids or gels or other substances in hollow chambers to isolate impact forces to the tool head instead of the human hand.

11. The tool handle of claim 1 including a hollow handle using liquids or gels or other substances moving in hollow chambers to act as a counter force to the main forces of impact in order to reduce vibration to the human hand.

12. The tool handle of claim 1 including a tool handle with multiple hand position grips which individually enclose a hand in each location allowing the hands-free, finger and thumb freedom to hold and manipulate other materials while keeping the tool handle in an active, ready position for instant use.

13. The tool handle of claim 1 including a nail removal claw positioned under the striking head of a hammer

14. A tool handle for use with a tool head such as a hammer, hatchet, axe, wrench, mallet, shovel, gun, nail gun, spade, fork, cutter, trowel, scraper, hook, chisel, rake, ratchet, torque wrench, jack, pump, pick, spike, lever, bar or pry comprising:
a handle extending from the tool head with;
an elevated bridge means, having a traction surface, for supporting and providing traction for the human body in a hands and knees, crawling position.

15. The tool handle of claim 14 having an elevated bridge means for protecting the hand from heat, cold, abrasion, cutting, bruising, puncturing, laceration, skinning while in a hands and knees, crawling position.

16. The tool handle of claim 14 including a plurality of slots that enclose the human hand allowing the finger and the thumb freedom to hold and manipulate other materials while keeping the tool handle in an active, ready position for instant use.

17. The tool handle of claim 14 including multiple hand grip locations.

18. The tool handle of claim 14 including multiple angles of surface contact including horizontal, diagonal, and vertical.

19. The tool handle of claim 14 including multiple center of gravity balance point adjustment means for adjusting the weight distribution of different tools for a variety of tool functions.

20. The tool handle of claim 14 including an enclosed multiple grip channel allowing the instant repositioning of hand grip locations without risk of losing control of the tool as a whole.

21. The tool handle of claim 14 including a hollow handle containing a liquid or other substance which provides an impact absorbing function.

22. The tool handle of claim 14 including a hollow handle containing a liquid or other substance which provides an anti-vibration function.

23. The tool handle of claim 14 including a tool handle with a hollow handle containing a stiff shaft which provides strength, bounce, and stiffness to the handle.

24. The tool handle of claim 14 including a hollow handle containing a heavy liquid or other substance which provides an extra leverage weight force energy during application of the tool and less leverage weight upon the tool backstroke to save energy.

25. The tool handle of claim 14 including a hollow handle using liquids or gels or other substances moving in hollow chambers to isolate impact forces to the tool head instead of the human hand.

26. The tool handle of claim 14 including a hollow handle using liquids or gels or other substances moving in hollow chambers to act as a counter force to the main forces of impact in order to reduce vibration to the hand.

27. The tool handle of claim 14 including a tool handle with multiple hand position grips which individually enclose a hand in each location allowing the hands-free, finger and thumb freedom to hold and manipulate other materials while keeping the tool handle in an active, ready poition for instant use.

28. The tool handle of claim 14 including a nail removal claw positioned under the striking head of a hammer.

29. A tool handle supporting, protecting, and providing traction for the human body in a hands and knees, crawling position

30. The tool handle of claim 29 including multiple hand grip locations.

31. The tool handle of claim 29 including an enclosed multiple grip channel allowing instant repositioning of hand grip locations without risk of losing control of the tool as a whole.

32. A tool handle of claim 29 including a hollow handle filled with a substance.
